(19) United States
(12) Patent Application Publication
(10) Pub. No.: US 2025/0065274 A1
(43) Pub. Date: Feb. 27, 2025

(54) Method for Biomaterial Purification

(71) Applicant: Solventum Intellectual Properties Company, Maplewood, MN (US)

(72) Inventors: Alexei M. Voloshin, Woodbury, MN (US); Rebecca A. Hochstein, St. Paul, MN (US)

(21) Appl. No.: 18/709,281

(22) PCT Filed: Oct. 24, 2022
(86) PCT No.: PCT/IB2022/060209

§ 371 Date: May 10, 2024

Related U.S. Application Data
(60) Provisional application No. 63/264,301, filed on Nov. 19, 2021.

(51) Int. Cl. B01D 67/00; B01D 65/02; B01D 71/56; B01D 71/78; G01N 1/40

(52) U.S. Cl. CPC B01D 67/00931; B01D 65/02; B01D 71/56; B01D 71/78; G01N 1/4077; G01N 2001/4088

(57) ABSTRACT

Described herein is a method. The method includes providing a filtration medium comprising a functionalized microporous membrane, wherein the functionalized microporous membrane comprises a plurality of guanidyl groups; contacting a biological fluid comprising a target with the filtration medium, wherein the biological fluid has a pH equal to or greater than an isoelectric point of the target; and eluting the target from the filtration medium with a second fluid to obtain a target solution, wherein the second fluid has a pH less than the pH of the biological fluid and less than an isoelectric point of the target.

### BACKGROUND

Manufacturing of large scale or commercial quantities of therapeutically useful targeted biomaterials, such as proteins or viral vectors, can be accomplished by growing cells that are engineered to produce a desired protein in bioreactors under controlled conditions. The technology used involves, for example, the fermentation of microorganisms which have been altered through recombinant DNA techniques or the culturing of mammalian cells which have been altered through hybridoma techniques. The cells are suspended in a broth which contains the salts, sugars, proteins, and various factors necessary to support the growth of particular cells. The desired product may be either secreted by the cells into the broth or retained within the cell body. The harvested broth is then processed to recover, purify, and concentrate the desired product.

The separation, or purification, of these targeted biomaterials from a heterogeneous mixture has proven to be a formidable task for at least the following reasons: the desired product often represents a small percentage of total cell culture fluid, which comprises significant quantities of particulate and soluble contaminants, and the cell culture fluid can comprise high salt concentrations.

As a result of these factors, extensive downstream processing has been necessarily used to yield high quantities of purified product. Such downstream processing includes the many stages of processing that take place subsequent to the production of the targeted biomaterial including, for example, centrifugation, cell disruption, mechanical sieving, microfiltration, ion-exchange, cross-flow filtration, affinity separation, sterile filtration, purification, and packaging. The downstream processing represents a major cost in the production of bioprocessed products.

Various filtration articles have been described for the purification or separation of targeted biomaterials from fluid mixtures.

### SUMMARY

There is a desire for filtration methods to increase the cost efficiency of isolation and/or purification of biomaterials from fluid samples. Such efficiency may be in the form of increased throughput, due to the reduction of process steps, increased throughput of a single step, and/or better removal of contaminants resulting in reduced loading of impurities onto downstream purification devices (such as chromatography columns or filters).

In one aspect, a method is described comprising: providing a filtration medium comprising a functionalized microporous membrane, wherein the functionalized microporous membrane comprises a plurality of guanidyl groups; contacting a biological fluid comprising a target with the filtration medium, wherein the biological fluid has a pH equal to or greater than an isoelectric point of the target; and eluting the target from the filtration medium with a second fluid to obtain a target solution, wherein the second fluid has a pH less than the pH of the biological fluid and less than an isoelectric point of the target.

The above summary is not intended to describe each embodiment. The details of one or more embodiments of the invention are also set forth in the description below. Other features, objects, and advantages will be apparent from the description and from the claims.

### DETAILED DESCRIPTION

As used herein, the term
“Alkyl” means a linear or branched, cyclic or acyclic, saturated monovalent hydrocarbon having from one to about twelve carbon atoms, e.g., methyl, ethyl, 1-propyl, 2-propyl, pentyl, and the like.
“Alkylene” means a linear saturated divalent hydrocarbon having from one to about twelve carbon atoms or a branched saturated divalent hydrocarbon having from three to about twelve carbon atoms, e.g., methylene, ethylene, propylene, 2-methylpropylene, pentylene, hexylene, and the like.
“Alkenyl” means a linear unsaturated monovalent hydrocarbon having from two to about twelve carbon atoms or a branched unsaturated hydrocarbon having from three to about twelve carbon atoms.
“Alkenoyl” means an alkenyl group that comprises a carbonyl (—C(═O)—) group.
“Aryl” means a monovalent aromatic, such as phenyl, naphthyl and the like.
“Guanidyl” means a functional group selected from at least one of guanidine and biguanide.
“Heteroarylene” refers to a divalent group that is aromatic and heterocyclic. That is, the heteroarylene includes at least one heteroatom in an aromatic ring having 5 or 6 members. Suitable heteroatoms are typically oxy, thio, or amino. The group can have one to five rings that are connected, fused, or a combination thereof. At least one ring is heteroaromatic and any other ring can be aromatic, non-aromatic, heterocyclic, carbocyclic, or a combination thereof. In some embodiments, the heteroarylene has up to 5 rings, up to 4 rings, up to 3 rings, up to 2 rings, or one ring. Examples of heteroarylene groups include, but are not limited to, triazine-diyl, pyridine-diyl, pyrimidine-diyl, pyridazine-diyl, and the like.
“hydrocarbyl” is inclusive of aryl and alkyl;
“(Hetero)hydrocarbyl” is inclusive of hydrocarbyl alkyl and aryl groups, and heterohydrocarbyl heteroalkyl and heteroaryl groups, the later comprising one or more catenary (in-chain) heteroatoms such as oxygen or nitrogen atoms. Heterohydrocarbyl may optionally contain one or more catenary (in-chain) functional groups including ester, amide, urea, urethane, and carbonate functional groups. Unless otherwise indicated, the non-polymeric (hetero)hydrocarbyl groups typically contain from 1 to 60 carbon atoms. Some examples of such heterohydrocarbyls as used herein include, but are not limited to, methoxy, ethoxy, propoxy, 4-diphenylaminobutyl, 2-(2′-phenoxyethoxy)ethyl, 3,6-dioxaheptyl, 3,6-dioxahexyl-6-phenyl, in addition to those described for “alkyl”, “heteroalkyl”, “aryl”, and “heteroaryl” supra.
“a”, “an”, and “the” are used interchangeably and mean one or more.
“and/or” is used to indicate one or both stated cases may occur, for example A and/or B includes, (A and B) and (A or B).

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

The present disclosure provides a method comprising providing a filtration medium comprising a functionalized microporous membrane, wherein the functionalized microporous membrane comprises a plurality of guanidyl groups. A biological fluid comprising a target can be contacted with the filtration medium. In some embodiments, the biological fluid can have a pH equal to or greater than an isoelectric point of the target. The target can be eluted from the filtration medium with a second fluid to obtain a target solution. In some embodiments, the second fluid can have a pH less than the pH of the biological fluid and less than an isoelectric point of the target to elute the target. The isoelectric point (pI) is the pH at which a particular target molecule carries no net electrical charge. Isoelectric point of targets can be measured by isoelectric focusing or estimated computationally using the isoelectric points of the individual amino acids making up the target protein molecule. In some embodiments, the filtration medium can be washed with a third fluid after the contacting the biological fluid with the filtration medium and before the eluting. The third fluid may have a pH less than the pH of the biological fluid and more than the pH of the second fluid. In some embodiments, the third fluid may have any pH sufficiently high to avoid substantial elution of the target while having an ionic strength greater than that of the biological fluid.

The filtration medium can be a microporous membrane substrate functionalized with guanidyl groups as described in WO 2017/069965 (Hester et al.). For example, the microporous membrane can be a porous polymeric substrate (such as sheet or film) comprising micropores with a mean flow pore size, as characterized by ASTM Standard Test Method No. F316-03, “Standard Test Methods for Pore Size Characteristics of Membrane Filters by Bubble Point and Mean Flow Pore Test,” of less than 5 micrometers. In one embodiment, the microporous membrane has a mean flow pore size of at least 0.1, 0.2, 0.5, 0.8, or even 1 micrometer; and at most 5, 3, or even 2 micrometers. The desired pore size may vary depending on the application. The microporous membrane can have a symmetric or asymmetric (e.g., gradient) distribution of pore size in the direction of fluid flow.

The microporous membrane may be formed from any suitable thermoplastic polymeric material. Suitable polymeric materials include, but are not limited to, polyolefins, poly(isoprenes), poly(butadienes), fluorinated polymers, chlorinated polymers, polyamides, polyimides, polyethers, poly(ether sulfones), poly(sulfones), poly(vinyl acetates), polyesters such as poly(lactic acid), copolymers of vinyl acetate, such as poly(ethylene)-co-poly(vinyl alcohol), poly(phosphazenes), poly(vinyl esters), poly(vinyl ethers), poly(vinyl alcohols), and poly(carbonates).

Suitable polyolefins include, but are not limited to, poly(ethylene), poly(propylene), poly(1-butene), copolymers of ethylene and propylene, alpha olefin copolymers (such as copolymers of ethylene or propylene with 1-butene, 1-hexene, 1-octene, and 1-decene), poly(ethylene-co-1-butene) and poly(ethylene-co-1-butene-co-1-hexene).

Suitable fluorinated polymers include, but are not limited to, poly(vinyl fluoride), poly(vinylidene fluoride), copolymers of vinylidene fluoride (such as poly(vinylidene fluoride-co-hexafluoropropylene), and copolymers of chlorotrifluoroethylene (such as poly(ethylene-co-chlorotrifluoroethylene).

Suitable polyamides include, but are not limited to, poly(iminoadipolyliminohexamethylene), poly(iminoadipolyliminodecamethylene), and polycaprolactam. Suitable polyimides include, but are not limited to, poly(pyromellitimide).

Suitable poly(ether sulfones) include, but are not limited to, poly(diphenylether sulfone) and poly(diphenylsulfone-co-diphenylene oxide sulfone).

Suitable copolymers of vinyl acetate include, but are not limited to, poly(ethylene-co-vinyl acetate) and such copolymers in which at least some of the acetate groups have been hydrolyzed to afford various poly(vinyl alcohols).

In one embodiment, the microporous membrane is a solvent-induced phase separation (SIPS) membrane. SIPS membranes are often made by preparing a homogeneous solution of a polymer in first solvent(s), casting the solution into desired shape, e.g. flat sheet or hollow fiber, contacting the cast solution with another second solvent that is a non-solvent for the polymer, but a solvent for the first solvent (i.e., the first solvent is miscible with the second solvent, but the polymer is not). Phase separation is induced by diffusion of the second solvent into the cast polymer solution and diffusion of the first solvent out of the polymer solution and into the second solvent, thus precipitating the polymer. The polymer-lean phase is removed and the polymer is dried to yield the porous structure. SIPS is also called Phase Inversion, or Diffusion-induced Phase Separation, or Nonsolvent-induced Phase Separation, such techniques are commonly known in the art. Microporous SIPS membranes are further disclosed in U.S. Pat. No. 6,056,529 (Meyering et al.), U.S. Pat. No. 6,267,916 (Meyering et al.), U.S. Pat. No. 6,413,070 (Meyering et al.), U.S. Pat. No. 6,776,940 (Meyering et al.), U.S. Pat. No. 3,876,738 (Marinacchio et al.), U.S. Pat. No. 3,928,517 (Knight et al.), U.S. Pat. No. 4,707,265 (Knight et al.), and U.S. Pat. No. 5,458,782 (Hou et al.).

In another embodiment, the microporous membrane is a thermally-induced phase separation (TIPS) membrane. TIPS membranes are often prepared by forming a homogenous solution of a thermoplastic material and a second material (such as a diluent), and optionally including a nucleating agent, by mixing at elevated temperatures in plastic compounding equipment, e.g., an extruder. The solution can be shaped by passing through an orifice plate or extrusion die, and upon cooling, the thermoplastic material crystallizes and phase separates from the second material. The crystallized thermoplastic material is often stretched. The second material is optionally removed either before or after stretching, leaving a porous polymeric structure. Microporous TIPS membranes are further disclosed in U.S. Pat. No. 4,529,256 (Shipman); U.S. Pat. No. 4,726,989 (Mrozinski); U.S. Pat. No. 4,867,881 (Kinzer); U.S. Pat. No. 5,120,594 (Mrozinski); U.S. Pat. No. 5,260,360 (Mrozinski); and U.S. Pat. No. 5,962,544 (Waller, Jr.). Some exemplary TIPS membranes comprise poly(vinylidene fluoride) (PVDF), polyolefins such as poly(ethylene) or poly(propylene), vinyl-containing polymers or copolymers such as ethylene-vinyl alcohol copolymers and butadiene-containing polymers or copolymers, and acrylate-containing polymers or copolymers. TIPS membranes comprising PVDF are further described in U.S. Pat. No. 7,338,692 (Smith et al.).

The microporous membrane of the present disclosure is treated to comprise a guanidyl functional group. Such functional groups comprise guanidine groups of Formula II or biguanidine groups of Formula III:

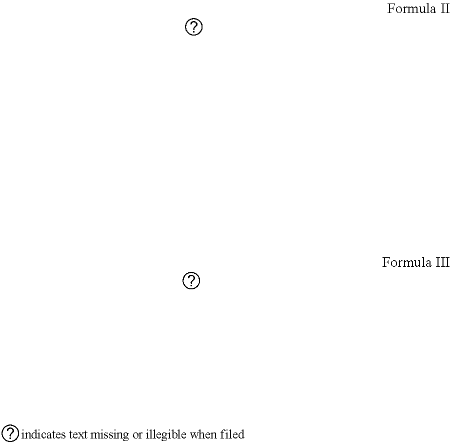

wherein R¹, R², R³, R⁴, R⁵, and R⁶ are independently selected from H or hydrocarbyl, preferably C₁-C₁₂ alkyl.

The guanidyl functional group is covalently bonded to the porous membrane substrate using techniques known in the art, such as the application of ionizing and/or non-ionizing radiation. Typically, the guanidyl functional group is grafted via a linking group directly onto the porous membrane substrate or onto a membrane substrate that has been treated with a primer layer.

In one embodiment, a porous membrane is treated with guanidyl groups derived from ligand-functional monomer units of the Formula IVa or b:

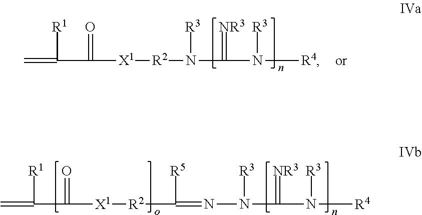

wherein R¹ is H or C₁-C₄ alkyl; R² is a (hetero)hydrocarbyl group, optionally containing an ester, amide, urethane or urea, preferably a divalent alkylene having 1 to 20 carbon atoms; each R³ is independently H or hydrocarbyl, preferably C₁-C₁₂ alkyl; R⁴ is H, C₁-C₁₂ alkyl or —N(R³)₂; R⁵ is H or hydrocarbyl, preferably C₁-C₁₂ alkyl or aryl; X¹ is —O— or —NR³—, o is 0 or 1, and n is 1 or 2.

Such guanidyl-containing monomers may be made by condensation of an alkenyl or alkenoyl compound, typically a (meth)acryloyl halide, a (meth)acryloylisocyanate, or an alkenylazlactone, with a compound of Formulas Va or Vb:

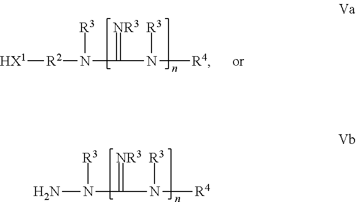

where R¹ is H or C₁-C₄ alkyl; R² is a (hetero)hydrocarbyl group, optionally containing an ester, amide, urethane or urea, preferably a divalent alkylene having 1 to 20 carbon atoms; each R³ is independently H or hydrocarbyl, preferably C₁-C₁₂ alkyl; R⁴ is H, C₁-C₁₂ alkyl or —N(R³)₂; and X¹ is —O— or —NR³—. Other ligand monomers may be made by condensation of a carbonyl containing monomer, such as acrolein, vinylmethylketone, diacetone acrylamide or acetoacetoxyethylmethacrylate, optionally in the presence of a reducing agent, with a compound of Formulas Va or Vb.

U.S. Pat. Publ. No. 2012/0252091 (Rasmussen et al.) discloses treating a porous substrate with a crosslinked polyamine polymer layer having ethyleneically unsaturated polymerizable groups, then grafting to this primer layer a polymer derived from the guanidyl-containing monomers above. U.S. Pat. Publ. No. 2015/0136698 (Bothof et al.) teaches grafting a substrate with the guanidyl-containing monomers above in the presence of a Type II photoinitiator. A Type II photoinitiator is an initiator which, when activated by actinic radiation, forms free radicals by hydrogen abstraction from a second (H-donor) compound to generate the actual initiating free radical. Such photoinitiators are known in the art.

In one embodiment, the grafted polymer layer derived from the guanidyl-containing monomer is a homopolymer of guanidyl monomer units.

In one embodiment, the grafted polymer layer derived from the guanidyl-containing monomer is a copolymer of guanidyl monomer units.

In addition to the guanidyl-containing monomer, in one embodiment, the grafted polymer layer derived from the guanidyl-containing monomer may be derived from other monomers such as multifunctional (meth)acryloyl monomers, including (meth)acrylate and (meth)acrylamide monomers. Examples of useful multifunctional (meth)acrylates include, but are not limited to, di(meth)acrylates, tri(meth)acrylates, and tetra(meth)acrylates, such as ethyleneglycol di(meth)acrylate, 1,6-hexanediol di(meth)acrylate, poly(ethylene glycol) di(meth)acrylates, polybutadiene di(meth)acrylate, polyurethane di(meth)acrylates, and propoxylated glycerin tri(meth)acrylate, methylenebisacrylamide, ethylenebisacrylamide, hexamethylenebisacrylamide, diacryloylpiperazine, and mixtures thereof. In one embodiment, the polymer layer may comprise hydrophilic comonomers, which comprise at least one alkenyl group, preferably a (meth)acryloyl group, and a hydrophilic group, including, but not limited to, alcohol, amino, sulfhydryl, oxyalkylene, or poly(oxyalkylene) and ionic groups, for providing hydrophilicity to the substrate, or for providing greater selectivity to the substrate when binding biomaterials. The hydrophilic groups may be neutral and/or have a positive charge. In one embodiment, a negatively charge comonomer may be included as long as it is in small enough amounts that it doesn't interfere with the binding interaction of the guanidyl groups. In some embodiments, the grafted polymer layer can be exemplary grafted layers comprising guanidyl monomers and mono- and multi-functional comonomers described in U.S. Pat. Publ. No. 2015/0136698 (Bothof et al.). In some embodiments, control of the grafted layer properties may be afforded through the use of one or more chain transfer agents, as described in U.S. Pat. Publ. No. 2010/0209693 (Hester et al.).

Guanidyl functional membranes may have the unusual property, among anion exchange functional membranes, of being capable of effectively binding viruses, not only at pH above the isoelectric point of the virus, but also at pH near the isoelectric point of the virus at which pH the virus has a net neutral charge. This capability may render guanidyl functional membranes particularly useful for the methods of this invention.

In one embodiment, the filtration medium comprises at least 0.01, 0.05, 0.1, or even 0.5 mmol; and at most 1, 1.5, or even 2 mmol of guanidyl groups per gram of the functionalized microporous membrane.

In one embodiment, the thickness of the filtration medium is at least 5, 10, 20, 25, or even 50 micrometers thick; and at most 800, 500, 200, or even 100 micrometers thick.

When used in a filtration application, in one embodiment, one or more layers of the filtration medium may be used. In some embodiments, each subsequent layer of the filtration medium may have a smaller effective fiber diameter so that finer contaminants may be retained. When a plurality of the filtration medium is used, each layer may have a symmetric or asymmetric (e.g., gradient) distribution of pore size through the direction of fluid flow, and the layers may have the same, or different mean flow pore size, porosity, amount of grafted guanidyl groups, tensile strength, and surface area. In some embodiments, each subsequent layer of the filtration medium may have a smaller effective pore size so that finer contaminants may be filtered.

Undesired proteins, such as protein impurities and host cell proteins, are also typically present in the harvest fluid. In one embodiment, the harvest fluid or cell culture fluid has a host cell protein concentration of at least 50,000; 100,000 or even 200,000 ng/mL and at most 2,000,000; 1,000,000; or even 500,000 ng/mL. These soluble proteins are smaller in nature and need to be separated from the monoclonal antibodies.

DNA, is a nucleotide sequence, which is the blueprint for replication of the cell. In one embodiment, the harvest fluid or cell culture fluid has a concentration of DNA of at least 10⁵, 10⁶, 10⁷, 10⁸, or even 10⁹ picograms/mL. After passing through the filtration media sequence of the present disclosure, the DNA of the filtrate can be reduced by a log reduction value of 3 or greater, many times by a log reduction of 4 or greater, even a log reduction value of 8 or greater.

In some embodiments, the target can be a virus or virus-like particle, including Influenza, Adeno-associated Virus, Poliovirus, Bacteriophage Phi-X174, Minute Virus of Mouse, Human Rhinovirus A, or Bacteriophage PM2. The target may have an isoelectric point greater than 3, greater than 4, greater than 4.5, greater than 5, greater than 5.5, greater than 6, greater than 6.5, greater than 7, greater than 7.5, greater than 8, greater than 8.5, or greater than 9. The target may have an isoelectric point between 3 and 10, between 3.5 and 9.5, between 4 and 9, or between 4 and 8. The isoelectric point of some targets are listed below.

| Virus | Isoelectric point |
|---|---|
| Influenza H3N2 | 6.5 |
| Adeno-associated virus 2 | 5.9 |
| Poliovirus | 6.9 |
| Phi-X174 | 6.6 |
| Minute Virus of Mouse | 4.5 |
| Hunan Rhinovirus A | 6.4 |
| Bacteriophage PM2 | 7.3 |

Isoelectric point can be determined by methods described in the journal article Isoelectric points of viruses. Michen, B., Graule., G. J Appl Microbiol. 2010 August; 109(2):388-397. For example, Isoelectric point can be measured by techniques based on isoelectric focusing, electrophoretic mobility (EM), Chromatofocusing and electrical detection using nanowire field effect transistors (EDN-FET).

To isolate and/or purify the target, such as the virus or virus-like particle, each of the contaminants must be removed to sufficient levels. Often the culture media comprises buffers, electrolytes, and/or sugars, which can impact the performance of the filter. In one embodiment, the biological fluid has a conductivity of more than 3 milliSiemens/cm (mS/cm), more than 5 mS/cm, more than 10 mS/cm, or more than 15 mS/cm, and at most not more than 25 mS/cm or not more than 35 mS/cm. In some embodiments, wherein the filtration medium is used in the process of purification and/or isolation, the second fluid (i.e., fluid to elute the target) may have a higher or lower conductivity depending on the previous processing steps. In one embodiment, the second fluid has a conductivity of less than 25 mS/cm, 20 mS/cm, 15 mS/cm or 10 mS/cm. In some embodiments, the third fluid (i.e., fluid to wash the filtration medium) may have a conductivity of more than 10 mS/cm, more than 15 mS/cm, and at most not more than 25 mS/cm or not more than 35 mS/cm. Conductivity can be measured using a conductivity meter/conductivity probe. A small electrical current flows between two electrodes set with a certain distance apart, usually around 1 cm. If there is a high concentration of ions in the solution, the conductance is high, resulting in a fast current.

It has been discovered in the present application that when a microporous membrane functionalized with ligands having guanidine or biguanide groups is used, a filtration device can be fashioned that has a high capacity for purification of a target, for example, virus or virus-like particle, from the fluid, a high capacity for substantial reduction of DNA from the fluid, and a high degree of host cell protein reduction, while also minimizing the number of process steps. In some embodiments, the biological fluid has a first host cell protein concentration, and the target solution has a second host cell protein concentration, wherein the second host cell protein concentration is at least 90%, 80%, 70%, 60%, 50%, 45%, 40%, 35%, 30%, 25%, 20%, 15% or 10% lower than the first host cell protein concentration. In some embodiments, the biological fluid has a first host DNA concentration, and the target solution has a second host cell DNA concentration, wherein the second host cell DNA concentration is at least 90%, 80%, 70%, 60%, 50%, 45%, 40%, 35%, 30%, 25%, 20%, 15% or 10% lower than the first host cell DNA concentration.

When utilized in the purification of the target, the filtration medium comprising guanidyl groups can bind the target and negatively-charged contaminants, particularly negatively charged host cell proteins at a pH above the isoelectric point, for example, when the pH of biological fluid is more than an isoelectric point of the target. In some embodiments, the biological fluid can have a pH more than 5, 5.5, 5, 6.5 or 7. In some embodiments, the biological fluid can have a pH between 6 and 9, between 6.5 and 9, between 7 and 9, or between 7.5 and 9. In some embodiments, the biological fluid can have a pH of about 5 to about 8.5. In some embodiments, the biological fluid has a pH of about 5 and no more than 9. In some embodiments, the biological fluid has a pH of at least 5 and no more than 8.5. In some embodiments, the filtration medium can then be washed using the third fluid. In some embodiments, the third fluid has a pH less than the pH of the biological fluid. In some embodiments, the third fluid has any pH sufficiently high to avoid substantial elution of the target while having an ionic strength greater than that of the biological fluid. In some embodiments, the third fluid has a pH greater than or equal to the isoelectric point of the target. In some embodiments, the third fluid has a pH less than the isoelectric point of the target. In some embodiments, the target can be eluted from the filtration medium using the second fluid with a pH below the isoelectric point of the target. In some embodiments, the second fluid can have a pH less than 8, 7.5, 7, 6.5, 6, or 5.5. In some embodiments, the second fluid can have a pH between 6.5 and 4, between 6 and 3.5, or between 5.5 and 3.

In some embodiments, the difference between the pH of the biological fluid and the pH of the second fluid is at least 1.5, 2, 2.5, 3, 3.5, or 4. In some embodiments, the difference between the pH of the biological fluid and the pH of the second fluid is about 1.5, about 2, about 2.5, about 3, about 3.5, or about 4. In some embodiments, the difference between the pH of the biological fluid and the pH of the second fluid is 1.5 to 4.5. In some embodiments, the difference between the pH of the biological fluid and the pH of the second fluid is 2 to 4.

In some embodiments, the biological fluid has a pH between about 7 and 9 and the second fluid has a pH between about 6 and 4. In some embodiments, the biological fluid has a pH between about 7.5 and 9 and the second fluid has a pH between about 6 and 4. In some embodiments, the biological fluid has a pH between about 8 and 9 and the second fluid has a pH between about 7 and 4. In some embodiments, the biological fluid has a pH between about 6.5 and 8 and the second fluid has a pH between about 5.5 and 3.5.

In some embodiments, the biological fluid may have a 7.5 pH and 10 mS/cm conductivity, the second fluid may be a buffer, for example, an acetate buffer with 5.5 pH and 5 mS/cm conductivity, and the third fluid may be a buffer, with 7 pH and 20 mS/cm conductivity.

As will be illustrated in the Examples below, it has been discovered that employing the method of the present disclosure, yields surprisingly high target recovery. In some embodiments, the biological fluid has a first target concentration, and the target solution has a second target concentration, wherein the second target concentration is at least 50%, 60%, 70%, 80%, 90%, 100%, 150%, 200%, 300%, 400% or 500% of the first target concentration.

### EXAMPLES

### pH and Conductivity Measurements

The pH and conductivity measurements were made using a calibrated Orion Star A215 pH/Conductivity Benchtop Multiparameter Meter (Thermo Fisher Scientific, Waltham, MA).

### Preparation of Phi-X174 Virus Feed Solution

Phi-X174 bacteriophage (ATCC 13706-B1) was obtained from ATCC (Manassas, VA). The virus culture was produced by growing a one liter culture of E. coli (ATCC 13706) in CRITERION Nutrient Broth (product No. C6471, Hardy Diagnostics, Santa Maria, CA) plus 5% sodium chloride at 37° C. with shaking to an OD (optical density) of 0.45. The culture was inoculated with 10¹⁰ plaque forming units (pfu) of Phi-X174 virus. The inoculated culture was grown for an additional 4 hours at 37° C. with shaking at 210 revolutions per minute (rpm). Cells were removed by centrifugation at 3700×g and the supernatant was filtered through a 0.2 micron polyethersulfone (PES) bottle top membrane filter (FISHERBRAND product No. FB12566506 obtained from Thermo Fisher Scientific). The resulting filtered solution had a Phi-X174 virus concentration of 4×10⁹ plaque-forming units per milliliter (pfu)/mL and was adjusted to have a pH of 7.5 using 2M Tris (pH 11.2), and a conductivity of 20 mS/cm using 5M sodium chloride.

### Determination of Phi-X174 Virus Concentration by Plaque Assay

Samples tested for Phi-X174 virus content were serially diluted (10-fold) with 1× phosphate buffered saline (PBS, pH 7.4). Molten top agar (nutrient broth with 0.9% agar, 2.5 mL) was mixed with 50 microliters of E. coli (ATCC 13706) host bacteria overnight culture and 100 microliters of diluted sample. The mixture was poured on top of a 100 millimeter nutrient agar petri plate and incubated for 3-4 hours at 37° C. Following incubation, the plaque-forming units (pfu) were counted. The number of pfu was correlated with virus particle number. The virus particle concentration (particles/mL) was calculated from the pfu count adjusted for dilution.

### Example 1. Preparation of AAV2 (Adeno-Associated Virus Type 2) Feed Solution

HEK293-F cells suspended in Gibco LV-MAX Production Medium (Thermo Fisher Scientific) were grown in an incubator using 2.8 L shaker flasks with shaking at a constant rate of 90 rpm (revolutions per minute). The incubator was maintained at 37° C. with 8% CO₂. When the cell density reached approximately 2×10⁶ cells/mL, a transfection cocktail was prepared and administered to the shaker flask.

The transfection cocktail consisted of the three plasmids pAAV2-RC2 Vector (Part No. VPK-422), pHelper Vector (Part No. 340202), and pAAV2-GFP Control Vector (Part No. AAV2-400) (all plasmids obtained from Cell Biolabs, San Diego, CA), and FECTOVIR-AAV2 transfection reagent (Polyplus Transfection, New York, NY). The transfection cocktail was prepared by first adding equimolar amounts of all three plasmids and the total plasmid amount was adjusted to be one microgram of plasmid mixture per million HEK cells used for transfection. Next, DMEM (Dulbecco's Modified Eagle Medium, obtained from Thermo Fisher Scientific) was added to the cocktail so that a final concentration of 5% DMEM (volume/volume) was achieved after adding the cocktail to the cell culture flask (i.e., volume/volume calculations for DMEM were adjusted based on the total cell culture volume). After the addition of DMEM, the cocktail was mixed and then one microliter of FectoVIR-AAV2 transfection reagent was added for every microgram of the plasmid mixture in the cocktail. The cocktail was gently mixed followed by incubation at room temperature for 45 minutes. Following the incubation step, the completed transfection cocktail was gently mixed and then added dropwise to the flask containing the cell culture. After addition of the transfection cocktail, the cells were grown in the incubator (37° C. with 8% CO₂) for 96 hours to induce the production of AAV2. The cell culture was pumped through a 3M Harvest RC BC4 capsule (obtained from the 3M Company, St. Paul, MN) at a constant flux of 200 LMH (L/m²/hour) to a throughput of 200 L/m² using a peristaltic pump. After loading the capsule with the cell culture, a solution of 50 mM, pH 7 Tris buffer (conductivity adjusted to 25 mS/cm using 5 M NaCl) was pumped through the capsule at a constant flux of 200 LMH and throughput of 200 L/m² to elute AAV2 capsids from the functionalized nonwoven media. This process was repeated 5 more times and the resulting elution samples were pooled. The pooled solution was analyzed for AAV2 capsid content using a ProGen AAV2 Xpress ELISA kit (obtained from American Research Products, Inc., Waltham, MA) according to the manufacturer's instructions. The AAV2 capsid content of the pooled solution was 4.5×10¹¹ capsids/mL. The final AAV2 feed solution had a pH of 7, conductivity of 25 mS/cm, and isoelectric point of 5.9 for AAV2.

### Example 2. Preparation of Capsule Containing Functionalized Microporous Membrane

Functionalized membranes were obtained by removing the AEX (anion-exchange) microporous membrane layers from commercially available 3M Polisher ST single-use anion exchange capsules (1 cm² capsule obtained from the 3M Company, Part No. EMP101STX080R). The AEX membrane from a 3M Polisher ST capsule was reported by the manufacture to be a polyamide microporous membrane, surface functionalized with a covalently grafted guanidinium functional polymer. A 3-layer stack of the membrane was reported to have a bovine serum albumin (BSA) dynamic binding capacity (DBC) between 7.9 and 12.0 mg/cm² at 10% breakthrough when challenged with a 1 mg/mL BSA solution in 25 mM Tris-HCl buffer (pH 8.0) containing 50 mM NaCl at a flow rate of 600 LMH. The 3M Polisher ST capsule contained a media package with the following media disc layers ordered proceeding from the upstream (feed) side of the media stack to the downstream (filtrate) side of the media stack: four layers of a quaternary ammonium functional nonwoven, three layers of AEX microporous membrane, and one layer of an unfunctionalized polyamide membrane. 3M Polisher ST capsules were cut open and the AEX membrane layers were removed.

A plastic filtration capsule was used for testing the functionalized microporous membrane. The capsule consisted of a sealed, circular housing. The capsule housing was prepared from two halves (upper and lower halves) which were mated and sealed together at the perimeter after the filtration elements were inserted in the internal cavity of the lower housing. Fluid inlet and vent ports were located on the upper portion of the housing and a fluid outlet port was located on the lower portion of the housing. The outlet port was centered in the middle of the lower housing surface.

Experimental capsules were prepared as follows. A single disc (1.6 cm diameter) of a 0.8 micron unfunctionalized polyamide membrane was placed in the bottom of the lower housing and overlayed with a stack of nine functionalized AEX microporous membrane discs. A single membrane of unfunctionalized polyamide membrane was placed on top of the stack. The upper and lower housings were mated together and ultrasonically welded using a Branson 20 kHz Ultrasonic welder (Model 2000xdt, Emerson Electric Company, St. Louis, MO) to form a finished filter capsule. The overall outer diameter of the finished capsule was about 4.3 cm and the overall height including inlet, outlet, and vent ports was about 4.8 cm. The effective filtration area of the capsule was 4.0 cm² and the bed volume of the media was 1.4 mL.

### Example 3

A finished capsule prepared according to Example 2 was attached through the inlet port to an AKTA avant FPLC chromatography system (GE Corporation, Boston, MA). The capsule was flushed with 10 mL of a solution of 25 mM, pH 7 Tris buffer (conductivity adjusted to 25 mS/cm using 5 M NaCl) at a constant flux of 600 LMH and then the AAV2 containing feed solution prepared in Example 1 (75 mL, 3.4×10¹³ AAV2 capsids) was pumped through the capsule at a constant flux of 600 LMH. The filtrate from the feed flow through was collected and analyzed for AAV2 capsid content. Next, the functionalized membrane was washed by pumping 15 mL of Tris acetate buffer (pH 6, conductivity 10 mS/cm) through the capsule at a constant flux of 600 LMH and collected in a separate flask. In a final elution step, AAV2 was eluted from the functionalized membrane by pumping 20 mL of acetate buffer (pH 4, conductivity 5 mS/cm) through the capsule at a constant flux of 600 LMH. The filtrate from the elution step was collected in a separate flask and analyzed for AAV2 capsid content. AAV2 capsid content was determined using a ProGen AAV2 Xpress ELISA kit. The results for AAV2 capsid recovery in the feed flow through step and the final elution step are presented in Table 1.

TABLE 1

| | Total AAV2 Capsids Recovered | Percent Recovery of AAV2 Capsids |
|---|---|---|
| Filtrate Sample | from the Feed Solution | from the Feed Solution |
| Feed Flow | below the minimum detection level | 0 |
| Through Step | of the assay | |
| Elution Step | 2.2 × 10¹³ | 64.7% |

### Example 4

A finished capsule prepared according to Example 2 was used with the exception that 6 functionalized membrane discs were incorporated in the capsule instead of 9 discs. The finished capsule was attached through the inlet port to an AKTA avant FPLC chromatography system. The capsule was flushed with 10 mL of a solution of 25 mM Tris buffer (pH 7.5, conductivity adjusted to 20 mS/cm using 5 M NaCl) at a constant flux of 600 LMH. Feed solution (50 mL, 1.9×10¹¹ PhiX-174 virus pfu, pH 7.5, conductivity of 20 mS/cm, and isoelectric point of 6.6 for PhiX-174) was pumped through the capsule at a constant flux of 600 LMH and collected in a separate flask. Next, the functionalized membrane was washed by pumping 15 mL of 25 mM Tris buffer (pH 7, conductivity 20 mS/cm) through the capsule at a constant flux of 600 LMH. The wash solution was collected in a separate flask. In the final elution step, PhiX-174 virus was eluted from the functionalized membrane by pumping 15.75 mL of acetate buffer (pH 5.5, conductivity 5 mS/cm) at a constant flux of 600 LMH through the capsule. The filtrate was collected in a separate flask. The filtrate collected from the elution step was analyzed for virus recovery using the Phi-X174 Plaque Assay.

DNA concentration of the feed solution before and after filtration was measured using the QUANT-IT PICOGREEN dsDNA assay (Thermo Fisher Scientific) according to the manufacturer's instructions. Total protein concentration before and after filtration was measured using a Pierce BCA Protein Assay Kit (Thermo Fisher Scientific) according to the manufacturer's instructions. Examination of the filtrate showed an 89.5% recovery of Phi-X174 virus, with a 94.8% reduction in DNA and a 92.9% reduction in total protein. The results are summarized in Tables 2-4.

TABLE 2
Total Phi-X174 Phage Content in Solution Measured Before and
After Filtration through a Functionalized Membrane Capsule

| | Total Phi-X174 | Percent Phage |
|---|---|---|
| | virus (pfu) | Recovery |
| Phi-X174 Phage Solution | 1.9 × 10¹¹ | ***** |
| Before Filtration | | |
| Phi-X174 Phage Solution | 1.7 × 10¹¹ | 89.5% |
| After Filtration | | |

TABLE 3
Total DNA Content in Solution Measured Before and After
Filtration through a Functionalized Membrane Capsule

| | Total DNA | Percent DNA |
|---|---|---|
| | (nanograms/mL) | Reduction |
| Phi-X174 Phage Solution | 59.5 | ***** |
| Before Filtration | | |
| Phi-X174 Phage Solution | 3.1 | 94.8% |
| After Filtration | | |

TABLE 4
Total Protein Content in Solution Measured Before and After
Filtration through a Functionalized Membrane Capsule

| | Total Protein | Percent Total Protein |
|---|---|---|
| | (micrograms/mL) | Reduction |
| Phi-X174 Phage Solution | 785.1 | ***** |
| Before Filtration | | |
| Phi-X174 Phage Solution | 56.1 | 92.9% |
| After Filtration | | |

Foreseeable modifications and alterations of this invention will be apparent to those skilled in the art without departing from the scope and spirit of this invention. This invention should not be restricted to the embodiments that are set forth in this application for illustrative purposes. To the extent that there is any conflict or discrepancy between this specification as written and the disclosure in any document mentioned or incorporated by reference herein, this specification as written will control.

1. A method, the method comprising:
providing a filtration medium comprising a functionalized microporous membrane, wherein the functionalized microporous membrane comprises a plurality of guanidyl groups;
contacting a biological fluid comprising a target with the filtration medium, wherein the biological fluid has a pH equal to or greater than an isoelectric point of the target; and
eluting the target from the filtration medium with a second fluid to obtain a target solution, wherein the second fluid has a pH less than the pH of the biological fluid and less than an isoelectric point of the target.

2. The method of claim 1, wherein the biological fluid has a conductivity more than 3 mS/cm.

3. The method of claim 1, wherein the second fluid has a conductivity less than 25 mS/cm.

4. The method of claim 1, comprising washing the filtration medium with a third fluid after contacting the biological fluid with the filtration medium and before the eluting.

5. The method of claim 4, wherein the third fluid has a pH less than the pH of the biological fluid and more than the pH of the second fluid.

6. The method of claim 4, wherein the third fluid has a conductivity more than 10 mS/cm.

7. The method of claim 1, wherein the target is a virus or virus-like particle, including Influenza, Adeno-associated Virus, Poliovirus, Bacteriophage Phi-X174, Minute Virus of Mouse, Human Rhinovirus A, or Bacteriophage PM2.

8. The method of claim 1, wherein the target has an isoelectric point greater than 4.

9. The method of claim 1, wherein the biological fluid has a pH more than 5.

10. The method of claim 1, wherein the second fluid has a pH less than 8.

11. The method of claim 1, wherein the filtration medium comprises at least 0.01 mmol of guanidyl groups per gram of the filtration medium.

12. The method of claim 1, wherein the biological fluid has a first host cell protein concentration, and the target solution has a second host cell protein concentration, wherein the second host cell protein concentration is at least 50% lower than the first host cell protein concentration.

13. The method of claim 1, wherein the biological fluid has a first host DNA concentration, and the target solution has a second host cell DNA concentration, wherein the second host cell DNA concentration is at least 50% lower than the first host cell DNA concentration.

14. The method of claim 1, wherein the biological fluid has a first target concentration, and the target solution has a second target concentration, wherein the second target concentration is greater than the first target concentration.

15. The method of claim 1, wherein the biological fluid has a first target concentration, and the target solution has a second target concentration, wherein the second target concentration is at least 200% of the first target concentration.
